(19) United States
(12) Patent Application Publication
(10) Pub. No.: US 2024/0313341 A1
(43) Pub. Date: Sep. 19, 2024

(54) TRACTION BATTERY VENTING SYSTEM AND VENTING METHOD

(71) Applicant: Ford Global Technologies, LLC, Dearborn, MI (US)

(72) Inventors: Brent Zapczynski, Dearborn, MI (US); Parikshit S. Gupte, West Bloomfield, MI (US); Robert Reiners, Ypsilanti, MI (US); Jonathan Mooney, Epping (GB); Peter Lucas-Nuelle, Ratinge (DE); Vaibhav P. Khotre, Basildon (GB); David Souch, Alresford (GB)

(21) Appl. No.: 18/183,339

(22) Filed: Mar. 14, 2023

(51) Int. Cl. H01M 50/358; B60L 50/64; H01M 50/209; H01M 50/249; H01M 50/317

(52) U.S. Cl. CPC H01M 50/358; B60L 50/64; H01M 50/209; H01M 50/249; H01M 50/317; H01M 2220/20

(57) ABSTRACT

A traction battery pack venting system includes an enclosure assembly that provides an interior area; at least one rail assembly; and a shear plate beneath the enclosure. The at least one rail assembly is configured to communicate vent byproducts received from within the enclosure assembly to an area between the shear plate and the enclosure assembly.

### TECHNICAL FIELD

This disclosure relates generally to compartmentalizing areas of a traction battery pack to facilitate venting battery cells of the traction battery pack.

### BACKGROUND

A traction battery pack of an electrified vehicle can include groups of battery cells arranged in one or more cell stacks. From time to time, pressure and thermal energy within one or more of the battery cells can increase. In response, gases and debris can be released from those battery cells.

### SUMMARY

In some aspects, the techniques described herein relate to a traction battery pack venting system, including: an enclosure assembly that provides an interior area; at least one rail assembly; and a shear plate beneath the enclosure, the at least one rail assembly configured to communicate vent byproducts received from within the enclosure assembly to an area between the shear plate and the enclosure assembly.

In some aspects, the techniques described herein relate to a traction battery pack venting system, wherein the at least one rail assembly is laterally outboard the enclosure assembly.

In some aspects, the techniques described herein relate to a traction battery pack venting system, further including a vehicle frame member, the vehicle frame member outboard the at least one rail assembly.

In some aspects, the techniques described herein relate to a traction battery pack venting system, wherein the at least one rail assembly includes a rail vent chamber that communicates the vent byproducts, the rail vent chamber including a primary portion extending horizontally alongside the enclosure assembly and at least one outlet portion that communicates the vent byproducts vertically downward to one of a plurality of shear plate venting chambers.

In some aspects, the techniques described herein relate to a traction battery venting system, wherein the shear plate vent chambers extend beneath the enclosure assembly from a driver side of the enclosure assembly to a passenger side of the enclosure assembly.

In some aspects, the techniques described herein relate to a traction battery venting system, wherein the shear plate vent chambers are provided by the shear plate and a floor of the enclosure assembly.

In some aspects, the techniques described herein relate to a traction battery venting system, wherein the shear plate vent chambers include at least three shear plate vent chambers.

In some aspects, the techniques described herein relate to a traction battery venting system, wherein the shear plate includes a plurality of openings that communicate vent byproducts from the shear plate venting chambers.

In some aspects, the techniques described herein relate to a traction battery venting system, wherein the openings open downward.

In some aspects, the techniques described herein relate to a traction battery venting system, further including at least one valve in the enclosure assembly, the at least one valve configured to communicate vent byproducts from an interior of the enclosure assembly to the rail assembly.

In some aspects, the techniques described herein relate to a traction battery venting system, further including a plurality of cell stacks housed within the interior area.

In some aspects, the techniques described herein relate to a traction battery venting method, including: venting vent byproducts from at least one battery cell through an enclosure assembly to a rail vent chamber; and directing the vent byproducts from the rail vent chamber to a shear plate vent chamber vertically beneath the enclosure assembly.

In some aspects, the techniques described herein relate to a traction battery venting method, wherein the rail vent chamber is provided within a rail assembly.

In some aspects, the techniques described herein relate to a traction battery venting method, further including directing the vent byproducts outboard from the enclosure assembly to the rail vent chamber.

In some aspects, the techniques described herein relate to a traction battery venting method, further including directing the vent byproducts from the shear plate vent chamber through at least one opening in the shear plate.

In some aspects, the techniques described herein relate to a traction battery venting method, wherein the openings open downward.

In some aspects, the techniques described herein relate to a traction battery venting method, wherein the shear plate vent chambers are provided by a shear plate and a floor of the enclosure assembly.

In some aspects, the techniques described herein relate to a traction battery venting method, wherein the rail vent chamber is a driver side rail vent chamber, wherein the shear plate venting chambers open to the driver side rail vent chamber and to a passenger side rail venting chamber.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1.

FIG. 3 illustrates another perspective view of the battery pack from FIG. 2 along with a shear plate, and selected portions of a rail assembly and a portion of a vehicle frame member expanded away from the battery pack.

FIG. 4 illustrates a close-up view of a portion of battery pack of FIG. 3 when the rail assembly is in an installed position.

FIG. 5 illustrates a close-up view of a portion of the rail assembly and shear plate of FIG. 4.

FIG. 6 illustrates a bottom view of the shear plate of FIG. 3.

FIG. 7 illustrates a section view taken at line 7-7 in FIG. 4.

FIG. 8 illustrates a section view taken at line 8-8 in FIG. 6.

### DETAILED DESCRIPTION

This disclosure details exemplary systems and methods and systems of venting a traction battery pack to direct gas and debris (i.e., vent byproducts) away from the traction battery pack.

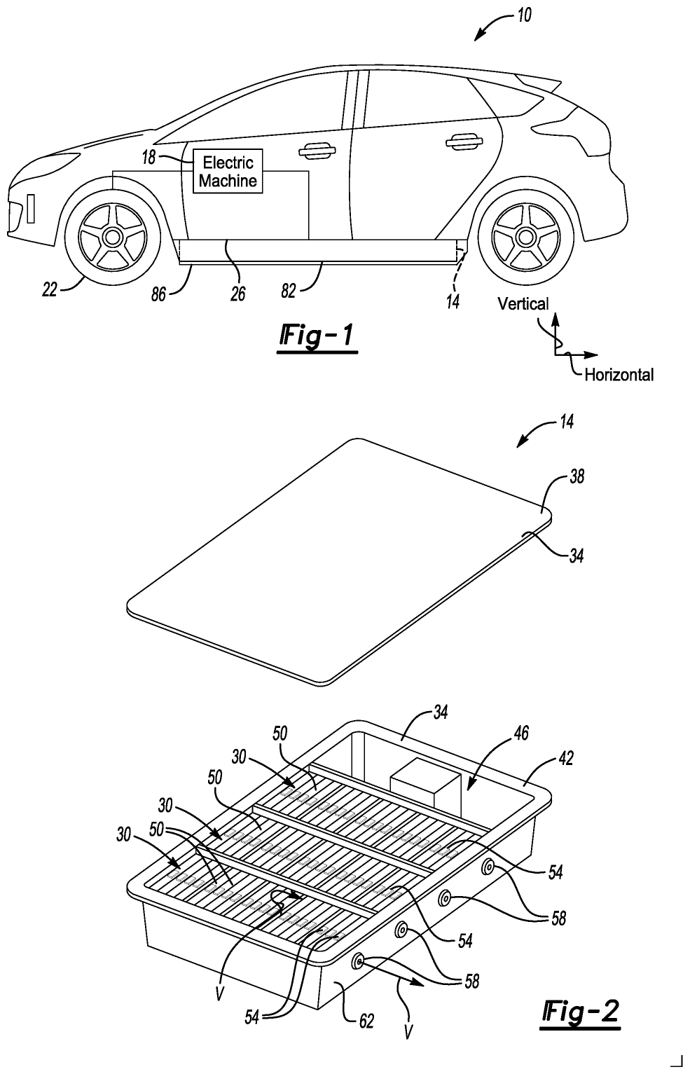

With reference to FIGS. 1 and 2, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

With reference now to FIGS. 2, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 46 that houses the cell stacks 30. The enclosure cover 38 can be secured to the enclosure tray 42 using mechanical fasteners (not shown), for example.

Each cell stack 30 includes a plurality of individual battery cells 50 arranged side-by-side relative to each other along the cell stack axis A. The battery cells 50 store and supply electrical power. Although specific numbers of the cell stacks 30 and cells 50 are illustrated in the various figures of this disclosure, the battery pack 14 could include any number of the cell stacks 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

From time to time, pressure and thermal energy within one or more of the battery cells 50 can increase. The pressure and thermal energy increase can be due to an overcharge condition, for example. The pressure and thermal energy increase can cause the associated battery cell 50 to rupture and release vent byproducts V, such as gas and debris, from within the battery cell 50.

The vent byproducts can be released from the associated battery cell 50 through a designated cell vent 54 within a housing of the cell 50. The cell vent 54 can be a membrane that yields in response to increased pressure, or through a ruptured area of the associated battery cell 50.

The vent byproducts V can then pass through one or more enclosure valves 58, which are, in this example, disposed in outboard sidewalls 62 of the enclosure tray 42.

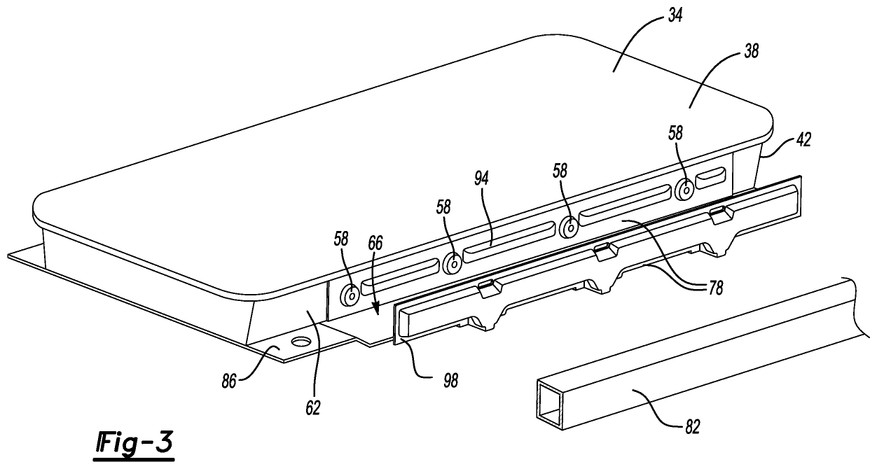

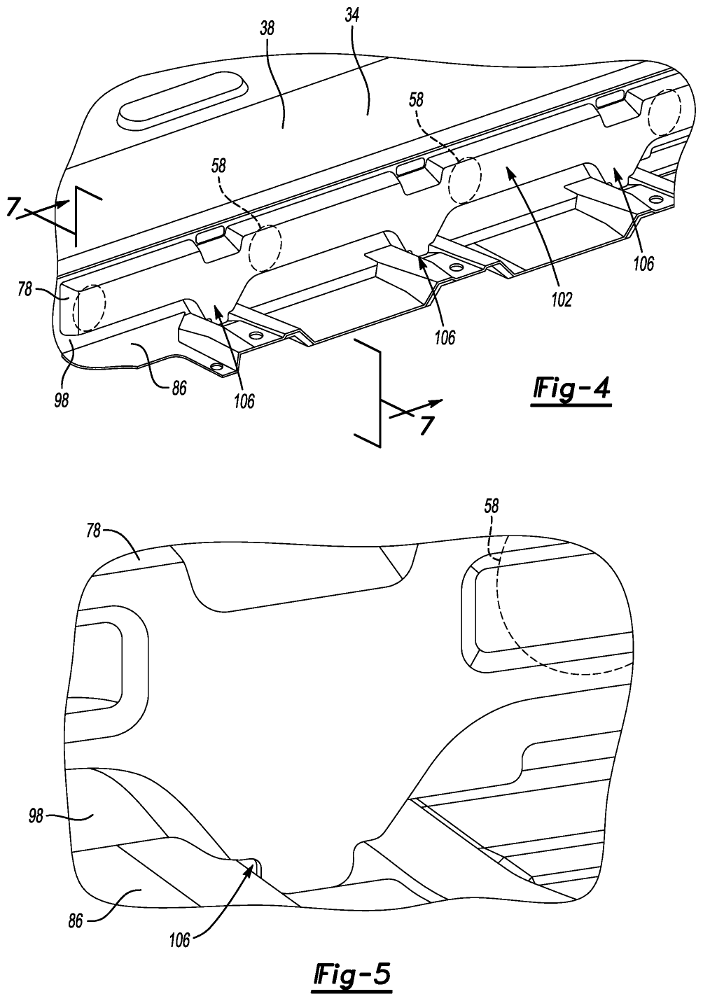

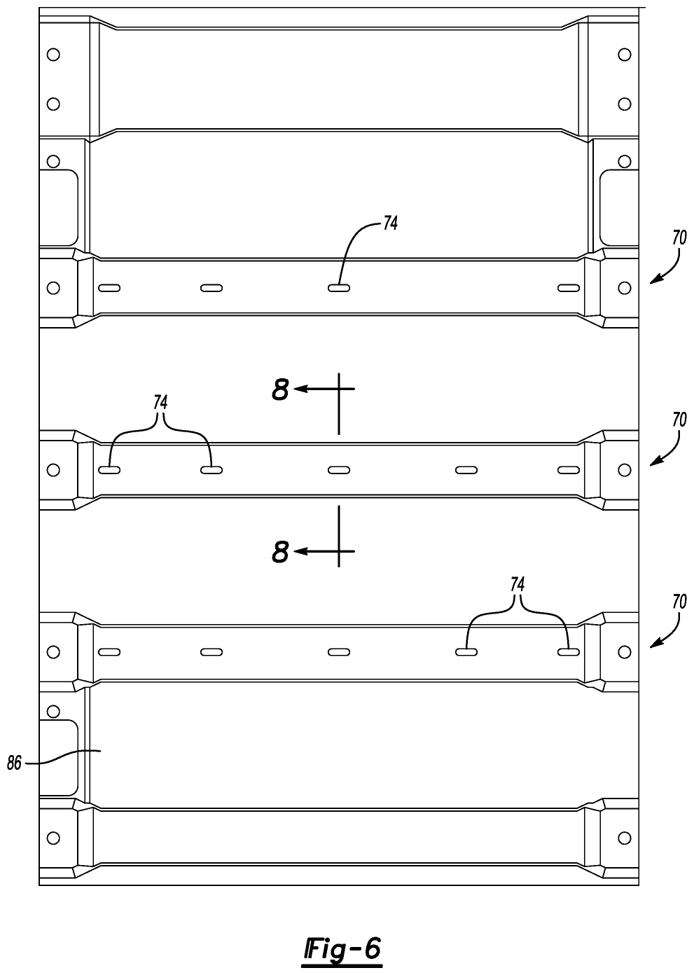

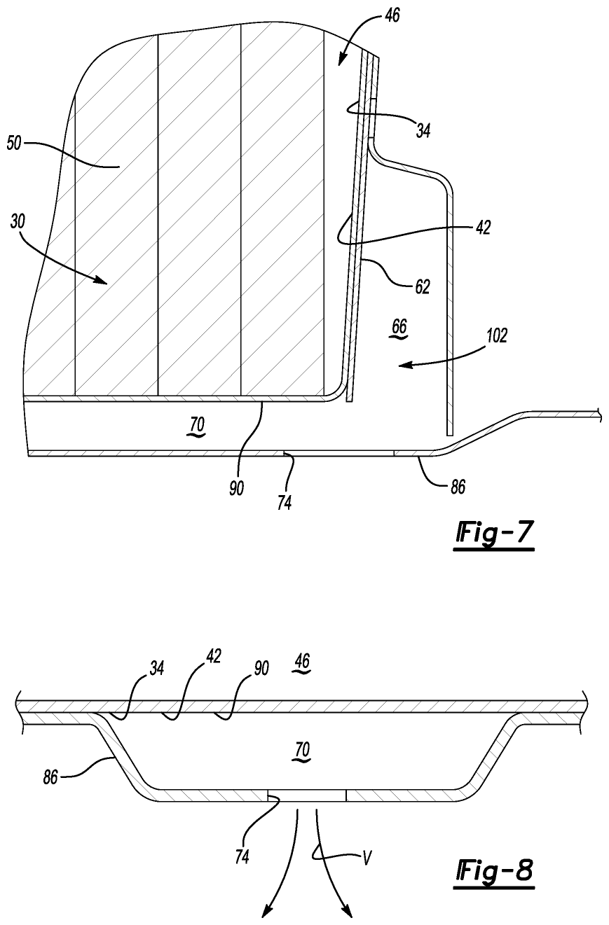

With reference now to FIGS. 3-8 with continuing reference to FIGS. 1 and 2, from the enclosure valves 58, the vent byproducts V move into a rail vent chamber 66, to a shear plate vent chamber 70, and then through the shear plate openings 74 to an ambient area outside the vehicle 10. The enclosure valves 58 can be one-way valves.

The vent byproducts V cool somewhat when communicating through the rail vent chamber 66 and the shear plate vent chamber 70. Thus, the temperature of the vent byproducts V when expelled from vehicle 10 is less than what the temperature would be if the vent byproducts V were expelled directly from the battery pack 14 through the enclosure valves 58. Reducing a temperature of the vent byproducts V prior to expelling the vent byproducts from the vehicle 10 can be desirable to reduce an intensity of thermal energy that is introduced to the ambient area due to the vent byproducts V.

In this example, rail assemblies 78 are disposed laterally outboard the enclosure assembly 34 alongside a driver side of the battery pack 14 and a passenger side of the battery pack 14. The rail assemblies 78 are inboard respective vehicle frame members 82 on the driver side and the passenger side of the vehicle 10.

A shear plate 86 is vertically beneath the battery pack 14 and, more specifically, beneath a floor 90 of the enclosure tray 42. The shear plate 86 can be secured to, among other things, the vehicle frame members 82 to help support the battery pack 14.

Vertical and horizonal, for purposes of this disclosure, are with reference to ground and a general orientation of the vehicle 10 during operation.

The rail assemblies 78, in this example, include an inner panel 94 and an outer panel 98 that establish the rail vent chamber 66. The rail vent chamber 66 has a primary portion 102 that extends horizontally along the outboard sides of the enclosure assembly 34. The vent byproducts V initially move from the enclosure valves 58 to the primary portion 102. The rail vent chamber 66 includes a plurality of outlet portions 106 that communicate the vent byproducts V downward to one of the shear plate vent chambers 70, which are between the shear plate 86 and the floor 90 of the enclosure assembly 34. Thus, the rail assemblies 78 are configured to communicate the vent byproducts V received from within the enclosure assembly 34 to an area between the shear plate 86 and the enclosure assembly 34.

A vertical top of the shear plate vent chambers 70 is provided by the floor 90 of the enclosure tray 42. A vertical bottom of the shear plate vent chambers 70 is provided by the shear plate 86. The shear plate vent chambers 70 extend beneath the enclosure assembly 34 from a driver side of the enclosure assembly 34 to a passenger side of the enclosure assembly 34. Each of the shear plate vent chambers 70 can receive vent byproducts from the rail vent chamber 66 on the driver side and the rail vent chamber 66 on the passenger side.

In this example, the shear plate 86 is stamped to provide depressions that form three shear plate vent chambers 70 that are separate from each other. The shear plate openings 74 open downward in this example, but could open at least partially horizontally.

In this example, five shear plate openings 74 are associated with each of the shear plate vent chambers 70. The five shear plate openings 74 are distributed in a cross-vehicle direction across the shear plate openings 74.

An exemplary traction battery venting method can include the step of venting vent byproducts from at least one battery cell 50 through the enclosure assembly 34 to at least one of the rail vent chambers 66. The venting through the enclosure assembly 34 can be venting in an outboard direction. From at least one of the rail vent chambers 66, the method can include directing the vent byproducts V downward from the rail vent chamber 66 to the shear plate vent chamber 70, which is vertically beneath the enclosure assembly 34. The vent byproducts V can move inboard through the rail vent chambers 66.

From the rail vent chambers 66, the method can include directing the vent byproducts V through at least one of the shear plate openings 74.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack venting system, comprising:
an enclosure assembly that provides an interior area;
at least one rail assembly; and
a shear plate beneath the enclosure, the at least one rail assembly configured to communicate vent byproducts received from within the enclosure assembly to an area between the shear plate and the enclosure assembly.

2. The traction battery pack venting system of claim 1, wherein the at least one rail assembly is laterally outboard the enclosure assembly.

3. The traction battery pack venting system of claim 2, further comprising a vehicle frame member, the vehicle frame member outboard the at least one rail assembly.

4. The traction battery pack venting system of claim 1, wherein the at least one rail assembly includes a rail vent chamber that communicates the vent byproducts, the rail vent chamber including a primary portion extending horizontally alongside the enclosure assembly and at least one outlet portion that communicates the vent byproducts vertically downward to one of a plurality of shear plate venting chambers.

5. The traction battery venting system of claim 4, wherein the shear plate vent chambers extend beneath the enclosure assembly from a driver side of the enclosure assembly to a passenger side of the enclosure assembly.

6. The traction battery venting system of claim 4, wherein the shear plate vent chambers are provided by the shear plate and a floor of the enclosure assembly.

7. The traction battery venting system of claim 4, wherein the shear plate vent chambers comprise at least three shear plate vent chambers.

8. The traction battery venting system of claim 4, wherein the shear plate includes a plurality of openings that communicate vent byproducts from the shear plate venting chambers.

9. The traction battery venting system of claim 8, wherein the openings open downward.

10. The traction battery venting system of claim 1, further comprising at least one valve in the enclosure assembly, the at least one valve configured to communicate vent byproducts from an interior of the enclosure assembly to the rail assembly.

11. The traction battery venting system of claim 1, further comprising a plurality of cell stacks housed within the interior area.

12. A traction battery venting method, comprising:
venting vent byproducts from at least one battery cell through an enclosure assembly to a rail vent chamber; and
directing the vent byproducts from the rail vent chamber to a shear plate vent chamber vertically beneath the enclosure assembly.

13. The traction battery venting method of claim 12, wherein the rail vent chamber is provided within a rail assembly.

14. The traction battery venting method of claim 12, further comprising directing the vent byproducts outboard from the enclosure assembly to the rail vent chamber.

15. The traction battery venting method of claim 12, further comprising directing the vent byproducts from the shear plate vent chamber through at least one opening in the shear plate.

16. The traction battery venting method of claim 15, wherein the openings open downward.

17. The traction battery venting method of claim 15, wherein the shear plate vent chambers are provided by a shear plate and a floor of the enclosure assembly.

18. The traction battery venting method of claim 15, wherein the rail vent chamber is a driver side rail vent chamber, wherein the shear plate venting chambers open to the driver side rail vent chamber and to a passenger side rail venting chamber.
